(19) United States
(12) Patent Application Publication
(10) Pub. No.: US 2016/0351290 A1
(43) Pub. Date: Dec. 1, 2016

(54) Fabrication method of DLC/Ti electrode with multi-interface layers for water treatment

(71) Applicant: Hybrid Interface Materials, Busan (KR)

(72) Inventor: Kwang Ho Kim, Busan (KR)

(73) Assignee: Hybrid Interface Materials, Busan (KR)

(21) Appl. No.: 14/979,410

(22) Filed: Dec. 27, 2015

(30) Foreign Application Priority Data
May 27, 2015 (KR) 10-2015-0073766

(51) Int. Cl. H01B 1/22

(52) U.S. Cl. CPC H01B 1/22

(57) ABSTRACT

In this layer, the Ti:N, Ti:C:N sublayer is formed on the etched Ti substrate, and DLC is coated, and afterwards, the proportion of the sp² carbon structure and the sp³ carbon structure is changed to lower the surface specific resistance, and by having electrochemical traits, the trait of enhancing the adhesion of the Ti substrate and the DLC layer is caused to have high durability and electrochemical traits, providing wide-area water-treatment DLC/Ti electrode manufacture method.

### FIELD OF TECHNOLOGY

This invention is about the fabrication method of multi-interface layers DLC-coated Ti electrodes with high conductivity, durability and electrochemical traits used for water treatment.

### BACKGROUND OF INVENTION

Electrodes used for the purpose of water treatment, creation or analysis of sodium hypochlorite must have the traits of chemical stability, high mechanical intensity, wide electrochemical potential window for creating hydrogen and oxygen, and low background current. Also, for electrodes to be utilized as commercial electrodes for water treatment, is needs high specific surface area and large area of various structure. Generally, the electrodes of large area have electrode materials of high price that they do not utilize electrodes composed of the target electrode material but manufacture the electrode coated with the electrode substances needed. For manufacture of wide area, substrates with high mechanical and chemical stability, may be manufactured in various forms and have low price are needed, and the coating electrode substance must have the high adhesion to the substrate 42-3 2015-05-27. Generally, Ti with chemical durability, high mechanical durability and low price are used as substrate.

As electrode material for water treatment, metallic oxides such as Pt, Ru, Ir and Sn or carbon are utilized. The Pt generally used in laboratories are chemically much stable, but as it has hydrogen evolution potential of OV that it is not appropriate for evolution research, and as it is highly priced, there are limitations to commercial utilization. Ru and Ir are utilized by coating RuO2, IrO2 or their composite oxide on the substrate surface of Ti. The metallic oxide electrodes have high corrosion, have low oxidization overvoltage on chloride ion compared to oxygen that they are frequently utilized in chloro-alkali industries producing chloric gases and hypochlorous acid, but because they have rather low efficiencies in producing OH radical and because it has low overvoltage to hydrogen, they are not utilized often as general water-treatment electrodes. Generally, carbon electrodes have high voltages of producing hydrogen compared to Pt that they are utilized often as electrodes for reduction reaction and for synthesizing organic compounds, and especially, glass carbon (GC) called glass-like carbon (GLC) have high mechanical durability and chemical stability that they are often utilized in laboratories. Yet they easily break due to glass-like fragility, and cannot be manufactured in forms with various structures, and because they cannot be coated easily to substrates such as Ti, there are limitations to utilizing these as commercial high-area electrode. The B developed from the late 1990s have wide hydrogen-oxygen generation potential window, and because it has high OH radical generation efficiency, it is evaluated as an outstanding water treatment electrode. However, the BDD electrodes manufactured through chemical vapor deposition above 2000° C. have high manufacture costs, and BDD in BDD coating to make into wide-area electrodes, if the generally used Ti is used as substrate, there is a large gap between the heat expansion coefficient that problems of coating becoming difficult occurs that Si is often used as substrate. Yet, the Si is also susceptible to breaking easily, and is difficult to make into various structures. As metal substrates, highly priced Nb is generally used that the manufacture costs are increased greatly.

As another carbon electrode, the diamond-like carbon (DLC) electrodes may be used as well. The DLC discovered in the 1970s have the hydrogen content up to 60%, and there are C-sp² structure with graphite-like traits and hydrogenated amorphous carbon hydrated as carbon structure (a-C—H) of amorphous structure with C-sp³ structure with diamond-like structure, and the latter is called i-carbon or tetrahedral amorphous carbon as well. This DLC structure differs greatly from the diamond structure, but as its characteristics, it has high hardness and low friction factor, and if it contains a high content of hydrogen, it has resistivity beyond 10¹⁰ Ωcm that it is not utilized as electrode but as coating substance for parts needing high durability. However, after 2000, it was revealed that by doping Pt, B, N substances in DLC structure, it is feasible to utilized DLC as electrode by lowering the surface specific resistance by attributing semiconductor characteristics, and especially, there were attempts to replace the BOD electrodes with the N-doped amorphous structure DLC electrode (a-C—N). However, the electrochemical DLC manufacture known so far have several hundreds of Ωcm of specific resistance, cannot be manufactured into various structures, and are being manufactured in the method of coating on the SI substrate with low mechanical durability.

However, the patent 10-0891540 of South Korea did suggest DLC coating including N, but did not consider the attempts to attribute conductivity to DLC, but mentions the subsidiary materials needing enforcement of hardness in DLC coating application.

### SUMMARY OF INVENTION

### Problem to be Solved

This invention seeks to provide manufacture methods of DLC/Ti electrode for water treatment, with DLC coating on Ti substrate similar to the traits of the BDD electrodes, being more outstanding compared to the GC with Ti substrate. In more detail, by attributing DLC coated multi-layer sublayer subcoating multi-layer on the Ti substrate which is difficult to coat with carbon structure, the high adhesion is achieved, and new methods of doping N within the DLC structure in different methods from the prior N-doping DLC manufacture is provided, and the low specific resistance, high mechanical harness, high specific surface area, wide oxygen-hydrogen causing potential windows are attributed on the electrode surface, and by attributing electrode activation, property far outstanding compared to GC is shown, and the carbon electrode manufacture method cheaper compared to BDD is provided.

### Means of Solving the Problem

According to the above purpose, in this invention, to create DLC/Ti electrode coated by DLC having high electrochemical traits compared to the prior carbon electrode, the Ti:N, Ti:C:N sublayer is provided on the etched Ti substrate, and the DLC is coated, and after heat-treatment (annealing), the sp² structure proportion within the DLC structure is Increased for electrochemical trait, and at the same time, the diamond trait due to the sp³ structure is provided.

To created water treatment large-area DLC electrode with outstanding mechanical hardness and chemical stability on the Ti substrate of various structures, two important manufacture processes must be taken.

First is to make the electrode have the form of high specific surface area, and to cause high adhesion between the substrate surface of complex form treated to have high specific surface area, and second is for DLC to have high electrical conductivity, outstanding mechanical durability and electrochemical activation.

For this, this invention

substrate for electrodes, made from Ti, Nb, W, or stainless steel;

The surface of the above substrate is roughened to give surface roughness;

Nitrified layer is formed on the above substrate;

By coating a combination layer of C and N on the abovementioned nitrified layer, the sublayer created from the combined layer (substrate: nitrified layer/substrate:C:N combined layer) including the nitrified layer and the combined layer containing C and N are formed;

the aforementioned sublayer, the DLC (Diamond like Carbon) layer is coated,

To form multilayer coating layer of substrate: nitrified layer/substrate:C:N combined layer/DLC on the substrate surface;

Manufacture of electrode with the coating layer in multilayer structure containing the above DLC is manufactured;

The electrode manufacture method of electrode attributing the electrochemical activation by heat-treating the abovementioned manufactured electrode is provided.

Also, this invention, as aforementioned, provides the electrode manufacture method with the trait of the heat heat-treating the electrode containing DLC has the temperature of 300 to 900° C.

Also, this invention, as aforementioned provides the electrode manufacture method with the trait of shortening the time of heat-treating the electrode containing the DLC with higher temperature.

Also this invention, as aforementioned provides the electrode manufacture method with the trait of shortening the electrode heat-treatment time in exponential function as the temperature gets higher.

this invention provides the electrode manufacture method with the annealing time of the electrode containing the DLC between 30 minutes to 5 hours.

Also, this invention, as mentioned above, provides the electrode manufacture method with the trait of etching or blasting the substance for surface roughness.

Also, this invention, as aforementioned, includes the process of cleansing the substrate before forming the nitrified layer after forming surface roughness on the substrate, and provides the electrode manufacture method of inserting inert gases in the chamber containing the substrate, discharging plasma and including further plasma cleansing process.

Also, this invention, as mentioned above, inserts the inert gases and nitrogen to evaporate to form a nitrified layer in the aforementioned substrate,

and to coat the combined layer containing C and N to insert and evaporate the inert gases, nitrogen and hydrocarbon gases,

and provides the electrode manufacture method of inserting and evaporating inert gases and hydrocarbon gases.

Also, this invention provides the water treatment electrodes manufactured in the aforementioned manufacture methods.

Also, this invention contains

Substrates for electrodes formed with Ti, Nb, W, or stainless steel;

sublayers containing the combined layers containing C and N and nitrified layer as coating layer of the aforementioned substrates; and

and DLC layers on the aforementioned sublayers,

The above DLC layers has the sp² layer and spa layers, and provides water treatment electrodes containing N from the aforementioned sublayer.

Also, this invention, as aforementioned, provides water treatment electrodes having minute ribs with surface roughness.

Also, this invention, as mentioned above, provides water treatment electrodes having minute ribs with surface roughness until the DLC coated surface layer of the water treatment electrode.

Also, this invention, as aforementioned, provides the water treatment electrodes with the thickness of DLC layer from 500 nm to 10 μm, and the thickness of sublayer from 10 to 100 nm.

### Effects of Invention

According to this invention, attributing surface roughness and forming sublayer and coating the DLC layer may cause strong adhesion of the DLC layer on the substrate. Especially, the annealing process conducted after coating the DLC layer eliminates the hydrogen (H) contained in the DLC layer, and transforms the atom combination structure in structures with conductivity, such as graphite to cause the high hardness of DLC and the conductivity. What is more better is that annealing expands the N element within the sublayer to cause the gradual dispersion within the DLC layer to intensify the adhesion of the substrate on the coating layer even further.

In other words, the manufacture method of heat-treated multilayer structure DLC/Ti electrode has high mechanical hardness and chemical stability, and may be manufactured in structures of various forms. By introducing multi-layer structure coating layer on the Ti metal substrate as sublayer, the DLC coating layer was able to have high adhesion, and by heat-treating the above multilayer structure (TiN/TiCN/DLC) in appropriate temperature, it was able to have the similar diamond-like material trait that the DLC has, in other words, high chemical stability and high mechanical hardness and the high electricity conductivity and outstanding electrochemical activation. Accordingly, the electrode of this invention showed even better electrochemical traits compared to the prior glassy carbon. Not only that, compared to the BDD electrode that is difficult to be coated on the Ti metal surface and has the high manufacture price and the manufacture conditions, in the similar reduction condition, it had more outstanding substances compared to the BBD electrodes that it provided DLC/Ti wide area electrodes that may be utilized as water treatment electrode for wide surfaces.

The commercial water treatment equipment utilizing such DLC/Ti wide-area electrodes have high efficiency and durability. Also, such electrodes have high chemical, electrical stability that it may be utilized as various electrode sensors that are manufactured with low costs.

### BRIEF DESCRIPTION OF DRAWINGS

FIG. 1 is the diagram of the DLC/Ti electrode with multilayer;

FIG. 2 is the thickness of the DLC coating layer of the manufactured DLC/TI electrode (A) Shot-blasted Ti substrate (B) DLC/Ti before annealing;

Surface SEM photo of the DLC/Ti heat-treated at (C), 600° C. (D), 800° C. (E), 900° C. (F);

FIG. 3 is the XRD result of the DLC/Ti surface heat-treated at 500° C.˜900° C.;

FIG. 4 is the CV measured on the 0.5 M Na2SO4 solution of the DLC/Ti electrode heat-treated at 400° C.˜900° C.;

FIG. 5 is the surface specific resistance of the DLC/Ti electrode heat-treated at 400° C.˜900° C.;

FIG. 6 is the CV measured at 0.5 M Na2SO4 solution with 50 mV K4Fe(CN)6 heat-treated at 400° C.˜900° C. of the heat-treated DLC/Ti electrode;

FIG. 7 is the CV measured from the 0.5 M Na2SO4 solution of the;

FIG. 8 is the CV measured from the 0.5 M Na2SO4 solution with the 50 mV K₄Fe(CN)₆ of the DLC/Ti electrode heat-treated at 900° C. and BDD, GC, Pt/Ti electrode;

FIG. 9 is the change of the electrode surface 1 hour before (A) and after (B) securing GC electrode at 2.3 V in the 0.5M sulfuric acid;

FIG. 10 is the change of the surface status after electrochemical evaluation when the Ti substrate is (A) surface etched and when not etched but with (B) DLC coating;

FIG. 11 is when the sublayer is not coated on the etched Ti substrate but DLC coated and shows the DLC material detached on the tape after surface tape testing;

FIG. 12 is the result of the scratch testing on the DLC/Ti surface when the sublayer is installed and not installed on the etched Ti substrate;

FIG. 13 is the Raman analysis result of the coating layer according to the annealing temperature of the DLC/Ti coating layer;

FIG. 14 is the surface hardness value of the electrode according to the annealing temperature of the DLC/Ti electrode;

FIG. 15 is the value of the substance change of H(A) and N(B) of the electrode surface according to the annealing of the DLC/Ti electrode.

### DETAILS OF THE INVENTION

The ideal details of this invention will be explained in detail by the attached Figure.

To manufacture the electrode coated by DLC, the substrate of Ti, Nb W, or stainless steel is prepared. Si or glass may be selected as substrate, but Ti may be selected as the most ideal substrate. Therefore, the following examples will explain the substrate of Ti, but the almost equal process is applied on the other materials for the production of electrode.

In other words, the roughness of the surface may be attributed by dry/wet etching or blasting to enforce the adhesion of the DLC coating layer, and the specific surface area is expanded.

The substrate given surface roughness is plasma cleansed by utilizing the inert gas, and nitrogen is inserted to form nitrified layer, and the combined coating layer containing C and N is formed to form sublayer. The sublayer enforces the adhesion between the substrate and the DLC layer to be coated. The sublayer is coated thinly in nm, and the upper DLC layer is coated with enough thickness from several hundred nm to several μm to prepare against coating layer peeling while using the electrode. The thickness of the sublayer formed by deposition layer is 10 to 250 nm, but after the annealing process as follows, the thickness lessens. Therefore, the thickness of the sublayer included in the finally produced electrode is 10 to 100 nm.

After coating the DLC layer, annealing is conducted to diffuse the substances of N and C to DLC layer, and the H component of the DLC layer is emitted to attribute conductivity to the DLC layer, enforcing the substrate adhesion. The annealing temperature may be 300 to 900° C., and ideally 400 to 900° C., and more ideally 400 to 800° C. When above 900° C., there may be the elution of the substrate atom that it is not ideal.

The annealing time changes exponentially according to the annealing temperature. In other words, the higher the annealing temperature is, the annealing time is shortened exponentially. Therefore, the annealing time may be 30 minutes to 5 hours, and ideally 2 hours to 3 hours.

Thus, this invention provides the methods forming the DCL/Ti electrode wherein a dual sublayer(3) is formed from TiN(2) and Ti:C:N on the etched Ti substrate(1) and DLC(5) is coated on the sublayer and then annealing is performed for the coated DLC on the Ti substrates to be attached strongly and the proportion of the sp² structure to be increased appropriately within the DLC coated carbon structure to improve electrochemical traits and have the diamond trait by the sp³ structure.

For substrate for DLC coating, Si, Ti, Nb and stainless steel may be used, but metal Ti that is chemically stable, corrosion-resistant and able to be manufactured in various structures is ideal. Largely two traits are needed for the adhesion of the Ti substrate and the DLC coating. It is ideal to let the substrate surface and coating substance to be structured by forming the appropriate roughness of the substrate surface is ideal. In other words, it is necessary for the substrate to play the role of the anchor holding onto the coating layer to form the physical occlusion between the two substances. The thin-layer coating manufactured in high temperature causes the peeling of the coating layer due to the heat expansion coefficient between the substrate and coating substance that it is necessary to install sublayer causing the concentration dispersion between the substrate and the coating layer (in other words, causing gradual changes of the coating layer).

In using metal substrate, chemical etching may be utilized, or shot-blasting giving surface roughness by abrasives may be used. In this invention, shot-blasting utilizing zirconia particles on the Ti was utilized, and to install sublayer of the DLC coating, the Ti:N(2) layer known to adhere strongly to Ti(1) was installed first, and afterwards, to form a concentration gradient of C and N between the DLC layer with the C as its main ingredient and the Ti:N layer(2), the Ti:C:N(3) was coated to form the sublayer(4) of Ti:N—Ti:C:N, and finally, DLC(5) was coated to manufacture multilayer DLC/Ti electrode(6) formed in Ti—Ti:N—Ti:C:N-DLC.

The DLC peel is manufactured in the DC-PECVD (DC-plasma enhanced chemical vapor deposition) method of DC-discharging the two electrodes installed within the vacuum reactor, and by inserting the reacting gas to chemically metalizing. Various hydrocarbon CxHy (CH₄, C₂H₂, etc.) gases or gases fusing these gases and hydrogen are used with Ar.

In this invention, to coat the sublayer and the DLC coating, for the cleansing and the activation of the Ti substrate, the Ar was inserted first to sputter Ti substrates by Ar, and Ar and N₂ (marked as Ar—N₂) are inserted to form Ti:N layer, and afterwards, the Ar—N₂—C₂H₂ combined gas is inserted to create Ti:C:N layer, and finally, the Ar—C₂H₂ combined gas is inserted to deposit the DLC layer of aC:H. If hydrocarbon CxHy gas is used to form DLC, the C structure of the created DLC becomes the amorphous hydrocarbonated a-C:H.

The finally coated a-C:H DLC carbon coating layer has the amorphous structure of C-sp² structure with the graphite-like traits and C-sp³'s graphite structure. If the proportion of C-sp³ layer of the DLC layer increases, it has the high hardness as the diamond, but because of the high specific resistance, it is not able to utilize the electrochemical trait. For the DLC to have electrochemical traits, N or B must be doped or the proportion of C-sp² must be increased to lower the specific resistance of the DLC to cause the low surface specific resistance, the condition of an electrode. To make the structure of DLC of a-C:N or a-C:N:H structure, the N₂ gas must be dripped onto the graphite substrate, or the hydrocarbon gas and N₂ gas must be combined in the Si substrate for chemical deposition. When using the N₂ gas on the graphite substrate, the graphite has low mechanical hardness and because it is difficult to make into various structures, it is difficult to make into water treatment electrodes mentioned in this invention, and when combining hydrocarbon gas and N2 gas on the Si substrate for deposition, the mechanical hardness of the Si is low that it is difficult to make wide-area electrode.

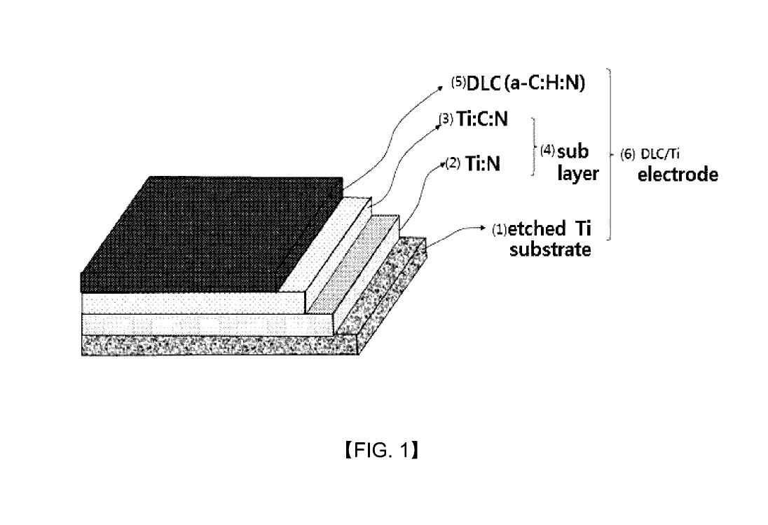

In this invention, the sublayer in multilayer(4) is installed in the aforementioned Ti substrate before DLC coating, and the DLC/Ti electrode coated and heat treated by DLC is provided. In other words, the multilayer coating layer Ti:N—TiC:N-DLC(a-C:H) formed on the Ti substrate is heat-treated, and in the Ti:N—TiC:N layer, the concentration gradient of the C and N substance between the Ti substrate and the DLC layer is formed to be more gradual to cause high adhesion between the Ti and DLC layer. At the same time, the N substance of the sublayer through annealing is dispersed within the DLC structure by solid diffusion, and by emitting the H substance out of the DLC structure, the H substance within the DLC is decreased to increase sp² substance to form part of a-C:H into a-C:H:N within the DLC structure to lower the surface specific resistance of the DLC surface, and to have electrochemical traits. Thus, the sublayer Ti:N—TiC:N layer serves not only the function of increasing the adhesion between the Ti and DLC layer in a-C:H but in annealing of the manufactured DLC/Ti, the N substance of the sublayer services the function of providing N substance into the DLC layer of the a-C:H structure that the DLC has a-C:H:N structure (N— dopped DLC). Such DLC/Ti electrode manufacture method of this invention is wholly different from the method used to make DLC in a-C:H carbon structure to have electrochemical traits. The overall chemical structure of the DLC electrode manufactured in this invention is a-C:H:N—Ti:C:N—Ti:N—Ti, and FIG. 1 shows the conceptual diagram of the DLC/Ti electrode.

This invention will be explained more specifically in detail through concrete example. However, the following examples are for the explanation of this invention, and the scope of this invention is not limited by the following example.

### EXAMPLE 1

For the manufacture of the DLC/Ti electrode with multilayer structure sublayer with electrochemical traits as in this invention, the Ti substrate shot-blasted to have surface roughness is deposited DC-PECVD (DC-plasma enhanced chemical vapor deposition) reactor of in 250 to 350° C., ideally 300° C., the degree of vacuum of 0.01 to 0.001 torr, and ideally approximately 0.0005, and first of all for the cleansing and surface etching of Ti substrate (1), Ar ion bombardment and plasma etching is conducted for several minutes (1 to 10 minutes, ideally t minutes), and afterwards, for the formation of nitrified layer (here Ti:N layer (2), the gas combining inert gas and nitrogen gas in volume proportions of 5-7:1 percent is inserted to deposit for 1 to 10 minutes. The nitrified layer of 10 to 100 nm thickness is formed. In this example, Ar 95 sccm, N2 15 sccm combined gas was inserted to deposit for 3 minutes.

Next, to form the combined coating layer of C and N, inert gas, nitrogen and hydrocarbon gas is deposited for 1 to 10 minutes in the volume proportion of 15˜20:2˜4:1

In the example, to form the Ti:C:N layer (3), combined gas of Ar 95 sccm, N2 15 sccm, C2H2 5 sccm was inserted and deposited for 3 minutes.

Finally, to coat DLC layer (5), the inert gas and hydrocarbon gas was supplied in volume proportion of 1:7-8, and deposited to 1 to 5 hours. Accordingly, DLC layer from 500 nm to 10 μm thickness is formed. The thickness of the DLC layer does not need to have the specific values but may be set appropriately to peel peeling and corrosion and consideration of manufacture productivity. The thickness of the sublayer does not need to be set, but in case of the sublayer, the thickness may decrease or become low due to the dispersion of the elements through the annealing process.

In this example, Ar 11 sccm, C2H2 85 sccm was inserted to deposit for 3 hours. To covert the structure of the finally produced DLC/Ti electrode (6) in a-C:H structure to a-C:H:N structure, vacuum annealing was conducted, and in the example of this invention, it was heat treated for respectively 2 hours within the 400° C.-900° C. in 100° C. interval. The physical chemistry and electrochemical traits of the finally manufactured DLC electrode was evaluated and compared with the glassy carbon (GC) electrode and boron-dopped diamond (BDD) electrode.

the research result, the temperature scope of annealing may be 400° C.˜900° C., and ideally 400° C.˜900° C., and more ideally 400° C.˜800° C.

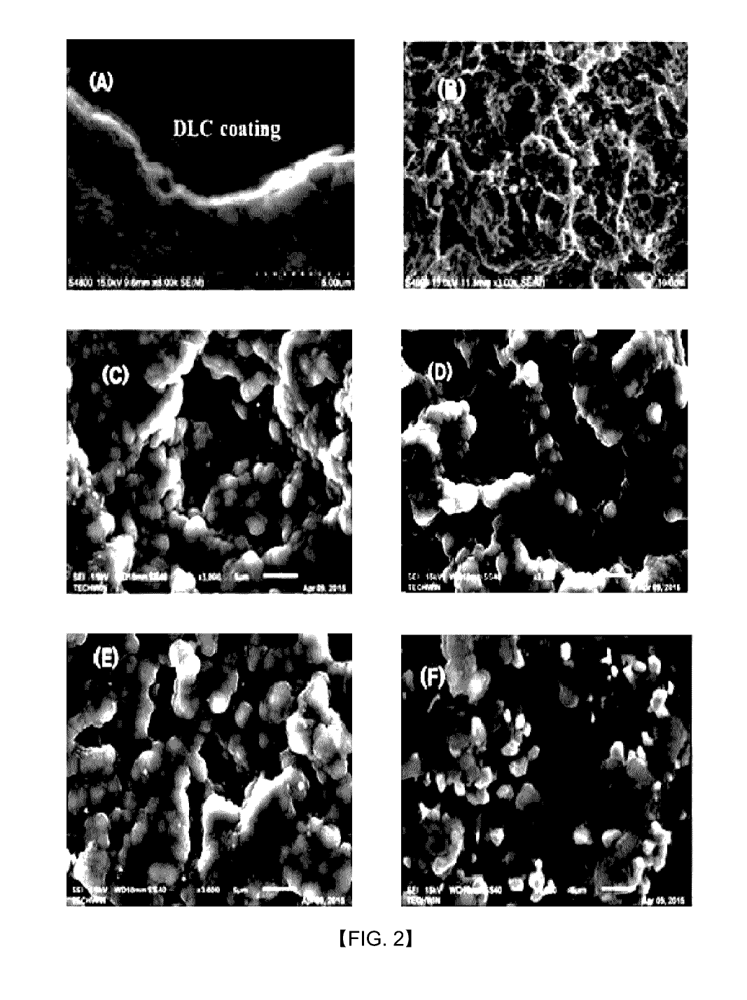

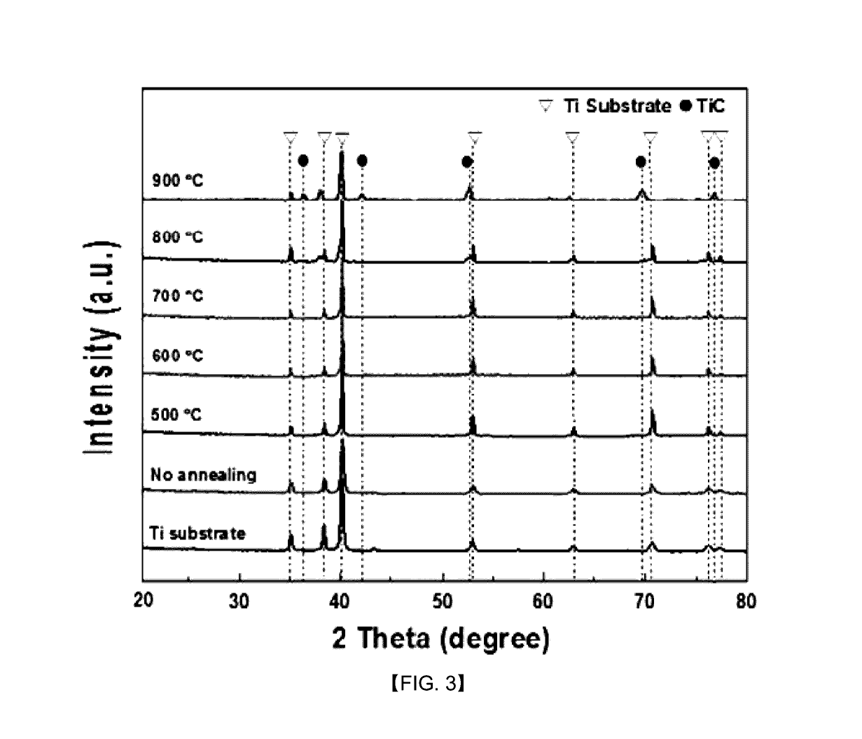

In the FIG. 2, the thickness of DLC coating layer of the DLC/Ti electrode before annealing (A), shot-blasted Ti substrate (B), DLC/Ti before annealing (C), the photos of SEM (scanning electron microscope, Hitahi, S-4800) heat-treated at 600° C. (D), 800° C. (E), 900° C. (F) were depicted. In (A) of FIG. 1, it is apparent that DLC layer of approximately 1.4 μm was formed, and that the DLC coating of shot-blasted Ti substrate is coated in combined form. In appearance, the surface change before annealing and after annealing to 800° C. cannot be observed, but in the result after annealing at 900° C., crystal grains in different forms on the DLC surface is observed, and this is because the Ti substance of the substrate was actively dispersed to the surface layer in the high temperature of 900° C. that it reacted with the DLC layer with carbon as its main substance to form TiC crystal, and can be observed in the analysis example of XRD (x-ray diffraction, D8-Discovery Brucker, CuKα, 40 kV) regarding the heat-treated DLC coating layer at 500° C.˜900° C. in FIG. 3. The Tic crystal structure cannot be observed on the surface before 800° C., but it may be observed from 900° C.

### EXAMPLE 2

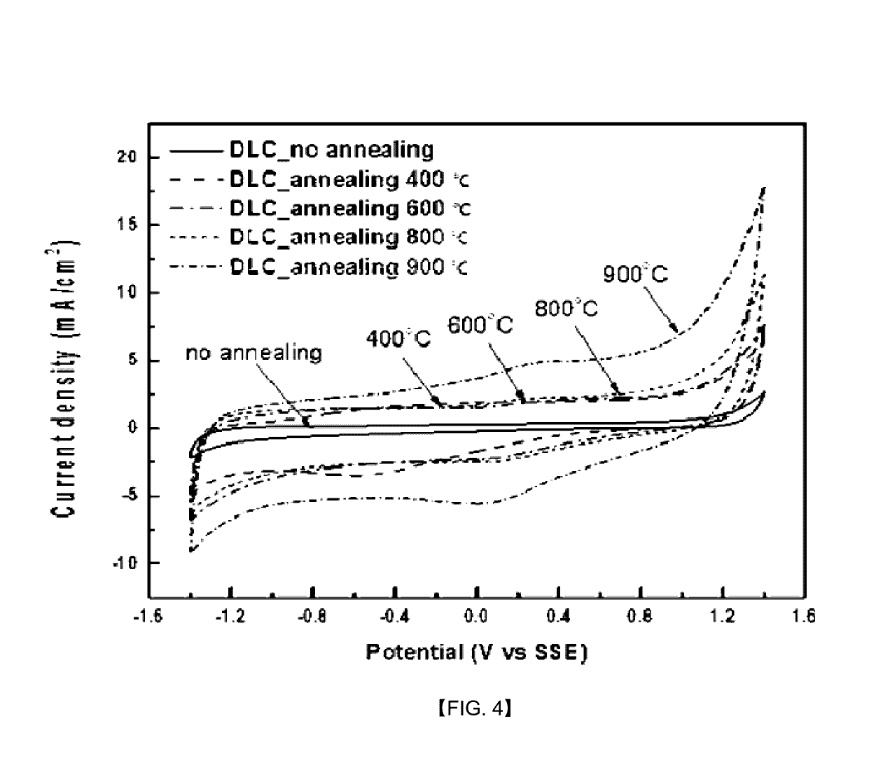

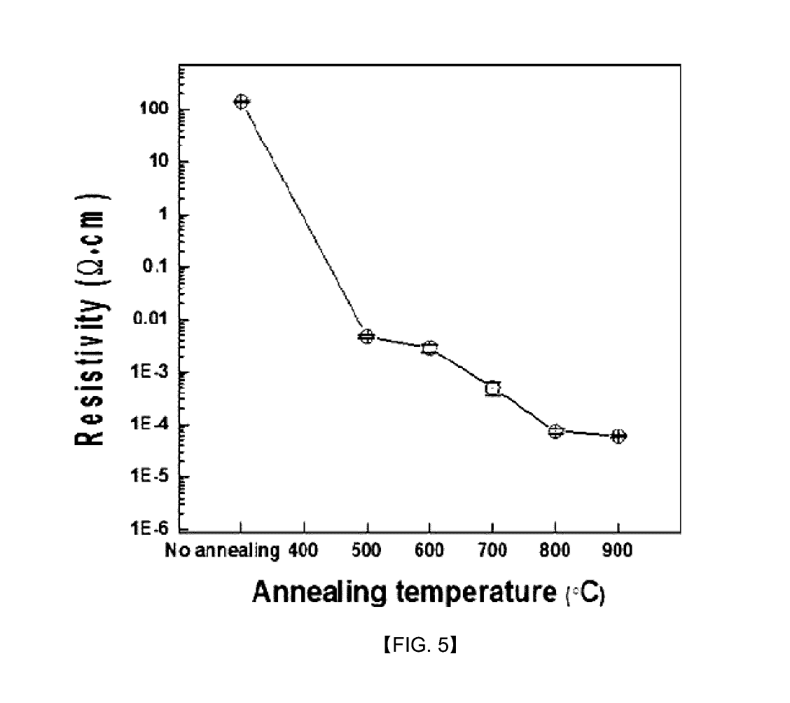

To see the electrochemical traits before and after annealing of the DLC/Ti electrode with multilayer sublayer, the manufactured DLC/Ti was set as positive pole, Pt as negative pole, and the SSE (Ag/AgCl (Siver/Siver chloride) as reference electrode to utilize electrolyte of 3M KCl to measure CV (cyclic voltammogram). The FIG. 4 depicts the CV measurement at 20V/sec in 0.5M Na2SO4 solution to view the electrochemical potential window causing oxygen and hydrogen according to the annealing of the DLC/Ti electrode. Electrodes not heat-treated are dominated by the C-sp3 structure within the DLC structure that tough it has high coating hardness, it had high specific surface area resistance, and low background current. However, when heat-treated, the N structures of Ti:N, Ti:C:N installed as sublayer is transferred to within the DLC of a-C:H structure that part of it changes to a-C:H:N structure, and due to the decrease of specific resistance of the electrode surface, the background current increases, and in FIG. 4, the increase of CV current within the oxygen-hydrogen potential can be seen. Though the change of the CV value within 400° C.˜800° C. is not large, from the 900° C., the abrupt increase of the CV's current range can be seen. This is not an ideal phenomenon from electrochemical perspectives as it deters the oxidization-reduction current of the material to be observed within oxygen-hydrogen potential. FIG. 5 depicts the measured surface specific resistance according to the annealing of the DLC/Ti electrode. The specific resistance of the DLC/Ti electrode not treated is 100 Ωcm or more, but as the temperature for annealing increases, the specific resistance value lowers abruptly that after annealing of 800° C., it decreases to 10⁻⁴ Ωcm, with lower electrode trait compared to the surface specific resistance value.

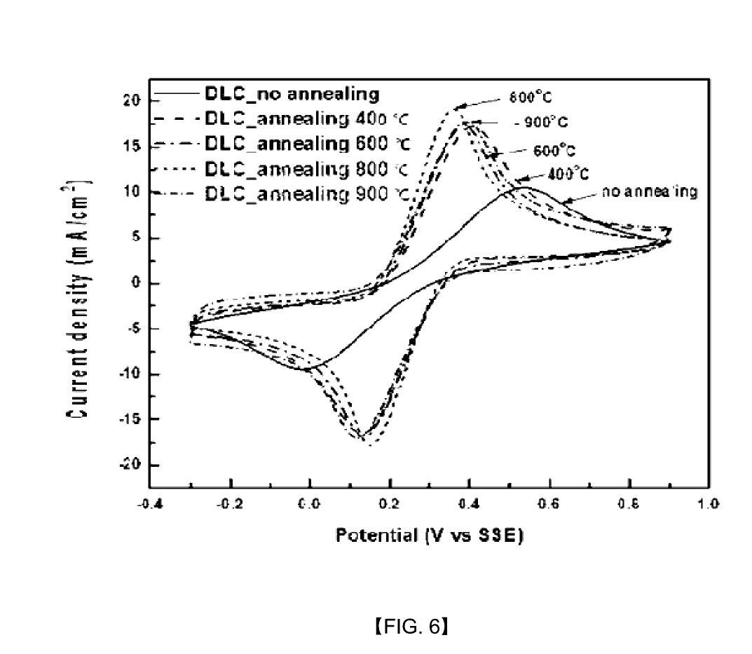

FIG. 6, to view the activity and sensitivity as manufactured electrode, and to see the changes of the CV in the most representative oxidization-reduction solution, the Fe(CN)₆ 3-/Fe(CN)₆ 4-ion solution, depicts the measurement result at 20 mV/sec in 0.5 M Na2SO4 solution with 50 mV K4Fe(CN)₆ utilizing DLC/Ti electrode. The DLC/Ti electrode not heat-treated have much Fe(CN)₆ 3-oxidization peak and Fe(CN)₆ 4-reduction peak, and as the annealing temperature increases, the space between the oxidization reduction peak decreases and the peak current heightens, and shows the highest peak current at the electrode heat-treated at 800° C., and lowers at 900° C. The more vivid the observed peak at CV, more accurate peak interpretation is possible to utilize as sensor, and the peak lowering and widening at CV shows the non-equivalence of the electrode surface site that the sensitivity of the electrode is decreasing. The peak lowering again at 900° C. is because the electrode activation and equivalence were lowered due to the TiC formed on the surface due to the solid dispersion of the Ti from the Ti substrate on the electrode surface due to heat-treatment at 900° C. that it is observed that the heat-treatment temperature for the DLC/Ti electrode manufactured in this invention to have the optimal electrochemical activation must not exceed 900° C.

### EXAMPLE 3

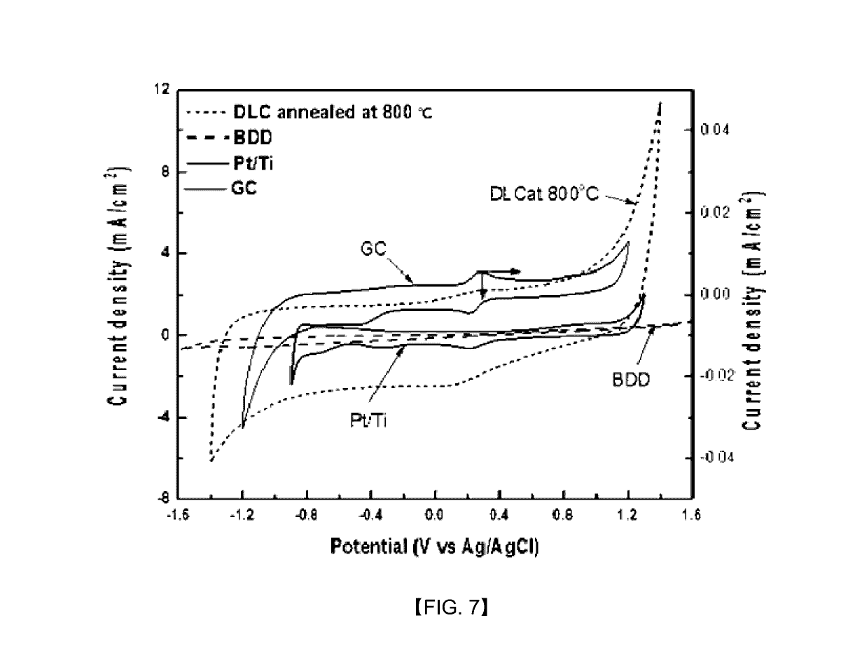

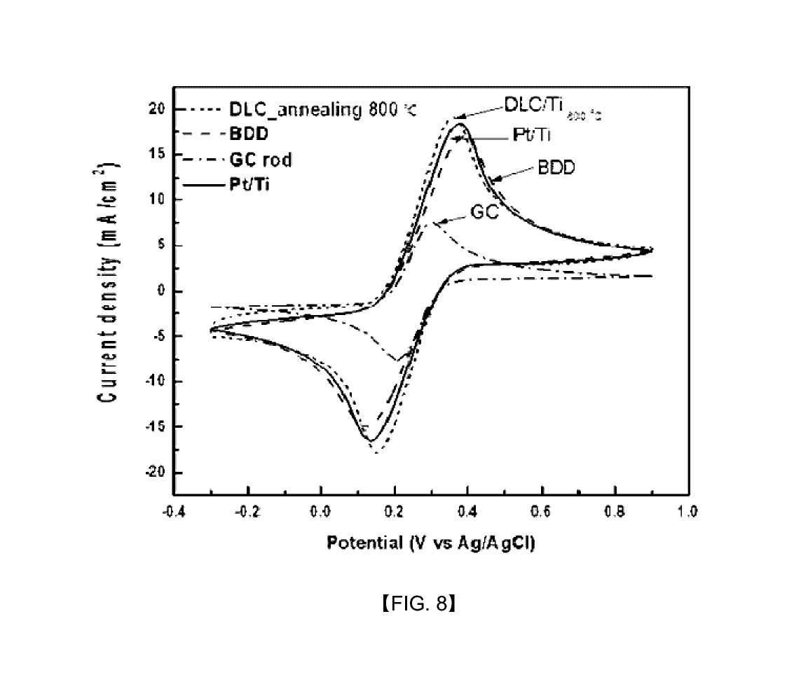

The examples to compare the DLC/Ti electrode heat-treated at 800° C. for the optimal electrochemical activation, and the electrochemical traits BDD GC, Pt/Ti electrode are shown in FIGS. 7 and 8. FIG. 7 shows the example of measuring and comparing 20 mV/sec in 0.5M Na₂SO₄ solution to see the electrochemical potential window occurring the oxygen and hydrogen of the compared electrodes are seen. The BDD, GC, and DLC electrodes, which are all carbon electrodes have high overvoltage to hydrogen compared to Pt electrode, and the heat-treated DLC/Ti electrodes have wider electrochemical potential window in which oxygen and hydrogen occurs compared go GC, and have smaller potential window compared to BDD. FIG. 8 shows the CV measurement at 2-mV/sec to see the CV changes at 0.5 M Na2SO4 solution of 50 mV K₄Fe(CN)₆ to see the CV changes at Fe(CN)₆ 3-/Fe(CN)₆ 4-. The CV of the DLC/Ti electrode heat treated at 800° C. and BDD, Pt/Ti is almost similar and minute, but the DLC/Ti electrode shows a sharper peak. The electrode has very low background current that generally low CV oxidization-reduction peak can be observed. From the actual examples of FIG. 7 and FIG. 8, it can be seen that the DLC/Ti manufactured by this invention has more outstanding electrochemical traits compared to the electrodes of GC and Pt/Ti that that it has equal or better electrode traits except that the electrochemical potential window is smaller.

### EXAMPLE 4

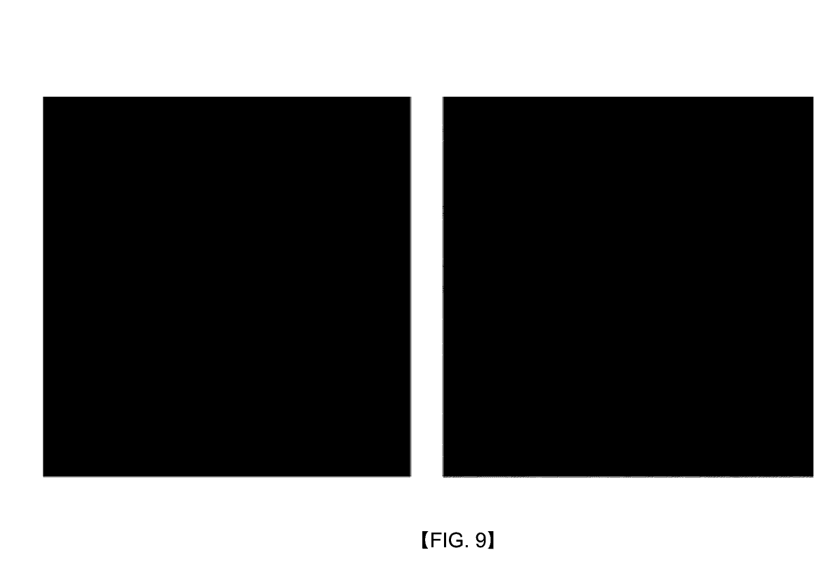

The oxidization reaction of carbon C, or the electrode potential of C+2H₂O=CO₂+4H⁺+4e⁻ may be oxidized into CO2 at 0.207 V that to see the electrochemical stability of the manufactured DLC/Ti electrode, to compare the DLC/Ti electrode and BDD, GC electrodes heat-treated at 800° C., current was applied for 1 hour in constant voltage of 2.3 V (vs. SSE), and the changes of the electrode surface was measured. The changes of the electrode surface in DLC/Ti electrode and BDD electrodes did not show the changes of the electrode surface before and after the conduction, but surface of the GC was etched by the oxidization reaction of C as seen in FIG. 9 that the DLC/Ti electrode is evaluated to have more outstanding stability compared to GC.

### EXAMPLE 5

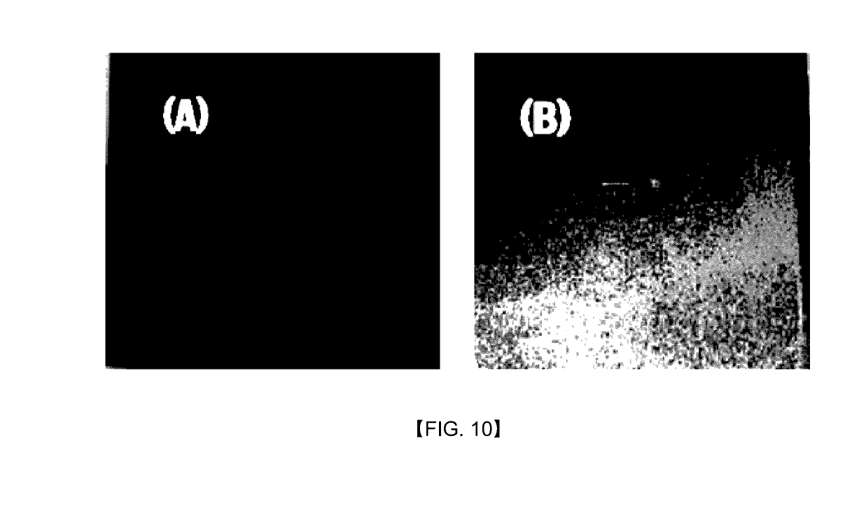

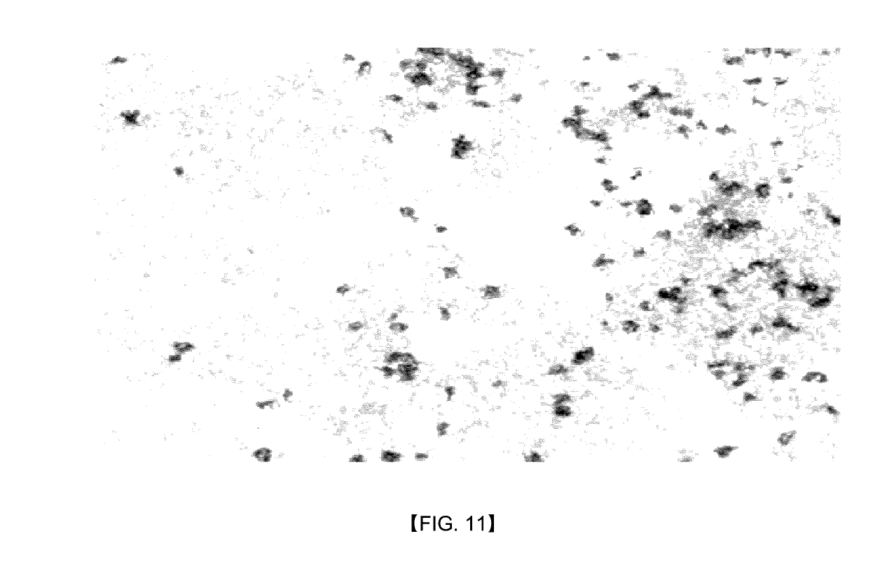

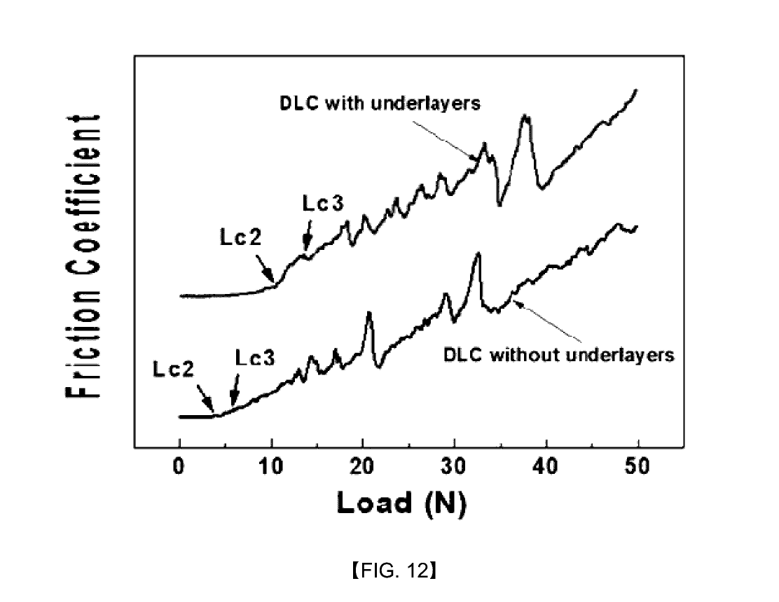

The adhesion of DLC coated on Ti substrate with roughness due to etching is an important trait. As mentioned before, the roughness of the Ti substrate has the role of anchoring the coating layer on the substrate. In FIG. 10, the invention coats DLC on the etched Ti substrate and not etched Ti substrate to observe the coating peeling phenomenon after the electrochemical experiments of the manufactured electrodes. In the Ti substrate not etched, regardless of the installation of the multilayer Ti:N—TiC:N layer before DLC coating, it fell easily to shock. The adhesion evaluation of the Ti substrate and the DLC coating layer was conducted due to the sublayer of the Ti:NTiC:N layer before DLC coating on the etched Ti substrate was conducted, and the results are shown in FIG. 11 and FIG. 12. In the FIG. 11, the sublayer of Ti:N—TiC:N was not installed on the etched Ti substrate, and after DLC coating, 3M tape was attached on the surface with specific strength, and the photo of the tape after conducting the tape test evaluating the adhesion of the coating layer is conducted. The black dots have fallen from the DLC coating layer, and on the DLC surface installing Ti:N—TiC:N sublayer on the etched Ti substrate, no DLC coating substance fell. FIG. 12 depicts the results of conducting scratch test (JNL tech., scratch tester) on the DLC/Ti electrode surface from the Ti:N—TiC:N sublayer. In FIG. 12, Lc1 is the point where peeling occurs, and Lc2 is the point where total peeling occurs that when there is no sublayer, Lc1 and Lc2 occurs at 4.1 N and 5.8 N, and if there is an sublayer, the Lc1 and Lc2 occurs at 10.0 N and 13.3 N that the sublayer installed between the Ti substrate and the DLC coating layer increases adhesion by nearly twice. Table 1 depicts the roughness value measured by surface roughness measurer (Mitutoyo, Sj-310) on the DLF/Ti surface when there are BDD, GC and sublayer coated on the Nb metal body. The roughness of the surface coated on the Ti is decided by the Ti etching, and the installation of the sublayer has no large influence on the surface roughness, and the DLC/Ti electrode surface has very large roughness compared to the GC electrode surface, and the increase of such specific surface area is one of the causes of the increase of oxidization-reduction peak and background current in DLC/Ti electrode compared to GC electrode in FIG. 7 and FIG. 8.

| [symbol] 1 | | DLC/Ti | DLC/Ti without |
|---|---|---|---|
| BDD | GC | with sublayer | sublayer |
| 2.002 μm | 0.006 μm 1 | 1.405 μm | 1.409 μm |

### EXAMPLE 6

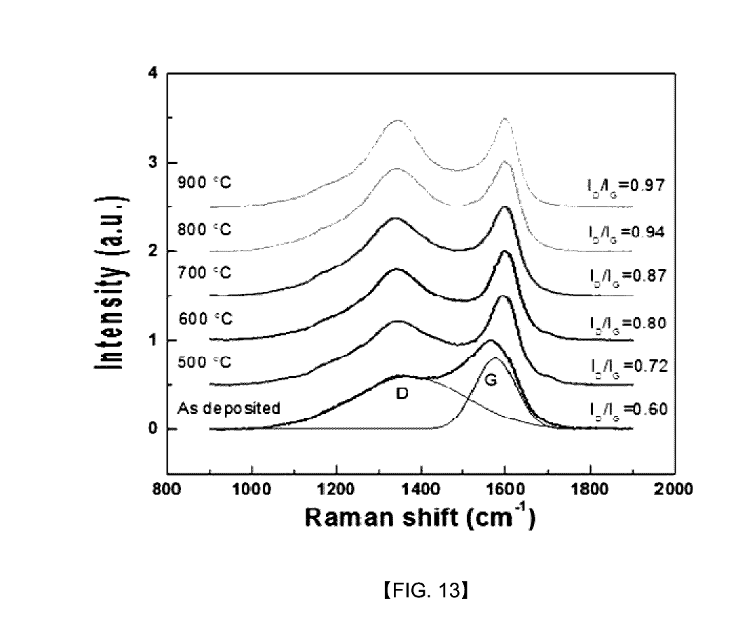

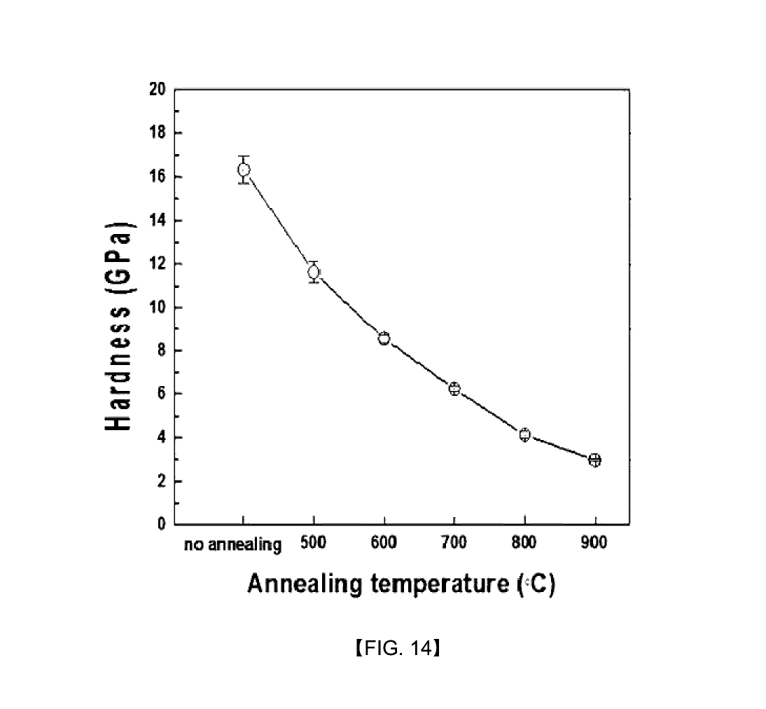

In the annealing of the DLC/Ti electrode manufactured by this invention, identifying the changes of the DLC carbon structure is an important starting point for understanding enhancing the traits of the DLC/Ti electrode. Thus, the DLC/Ti electrode structure changes according to the annealing temperature were measured, and the result is depicted in FIG. 13. FIG. 13 depicts the example of utilizing the Raman spectrometer (Hobbia, Jobin-Yvon) utilized to identify the DLC carbon structure to measure the Raman spectrum on the DLC/Ti electrode surface. Generally, in DLC structure, D peak appears at 1325-1375 cm⁻¹ and G peak at 1550-1575 cm⁻¹. G peak is due to the carbon atom stretching vibration in sp² combination, and the D peak is known to be due to the breathing mode of the carbon atom in ring-shaped sp² combination. The DLC/Ti electrode surface is in broad form of the D peak and G peak before annealing, but after annealing, the D peak appears regularly at 1375 cm⁻ and G peak appears regularly at 1599.5 cm⁻¹, with the peak position increasing compared to before annealing. This shows that the combination amount of the spa within the thin layer has decreased after annealing. Also, the width of the G peak narrows when the temperature of the annealing increases, and the proportion (ID/IG) increases as the intensity of the D peak and G peak increases. That G peak has a high width means that the structure of sp² with much combination with the carbon with different vibration intervals from sp³ structure, and the D peak widening means that the structure carbon of sp³ is combined more on sp³ and sp², and that the disorder of sp³ is increasing. The ID/IG intensity proportion increases with the increase of the annealing temperature, and this means the increase of the substance of sp². In other words, as the annealing temperature increases, the position of the G peak and the D peak increases and the width dwindles for the ID/IG to increase, and this means that the DLC layer has a decreased hardness due to the decrease of the substances of H and sp³ because the DLC layer is a combined structure and that the DLC's specific resistance value decreases due to the relative increase of the sp² graphite structure's relative increase. The equivalence of the surface site of the electrode increasing due to such structural change is the reason sensitivity of the DLC/Ti electrode enhancing as explained in FIG. 6. FIG. 14 depicts the actual example of measuring the changes of the surface hardness of the DLC/Ti according to the annealing temperature. As the temperature of annealing increases, the ta (tetrahedral amorphous)-C of the sp³ structure showing diamond trait as in FIG. 1 decreases, and the hardness of the DLC decreases. However, the hardness of the surface of the DLC/Ti electrode that underwent annealing, at 800° C. showing the most outstanding electrochemical trait is approximately 4.2 GPa, larger than approximately 3 GPa, the hardness of GC that the mechanical hardness of the surface of the DLC/Ti electrode with high electrochemical trait is still high.

### EXAMPLE 7

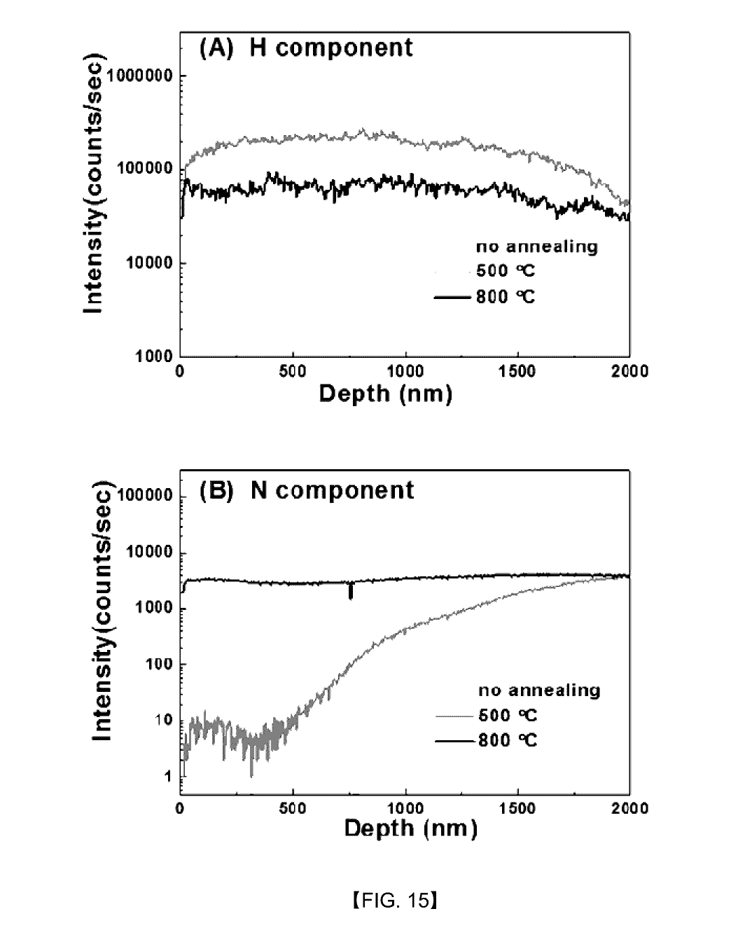

As explained in FIG. 1, if the sublayer of Ti:N—Ti:C:N is placed between the Ti substrate and the DLC layer, as explained in FIG. 11 and FIG. 12, it maximizes adhesion and the N substance of the sublayer is dispersed into the DLC layer that the substantial example of measuring the proportion change of the H substance (A) and N substance (B) according to the depth of the DLC/Ti electrode that was processed through annealing in 500° C. and 800° C. was measured through SIMS (secondary ion mass spectrometry; Camera, Ims6f magnetic detector SIMS) as shown in FIG. 15. In a-C:H not processed through annealing, the proportion of H substance was very high, but decreased greatly when the annealing temperature was 500° C. and 800° C. The H substance is very low in the DLC/Ti surface not processed through annealing, and though the N substance increases to the sublayers, but if annealing at 500° C. and 800° C., N substance existed on the surface. Table 2 depicts the example of measuring the atomic % of the C, N, O, Ti substance on the DLC surface when the DLC/Ti electrode was processed through annealing by XPS (X-ray photoelectron spectroscopy; Thermo Fisher Scientific, Theta probe AR-XPS). When not annealing the DLC/Ti electrode, the Ti and N substance rarely appears on the surface, but as the annealing temperature is increased, the Ti and N substances disperses from the sublayer to increase the substances. The T substance in 800° C. is by the TIC substance detected on the electrode surface annealing at 800° C. From such results, annealing the DLC/Ti electrode manufactured by this invention causes the carbon structure substance of the DLC layer to be a-c:H:N form.

TABLE 2
The atomic % of the substance content of the electrode surface
according to the annealing temperature of the DLC/Ti electrode

| | | Annealing | Annealing | Annealing |
|---|---|---|---|---|
| Substance | No-annealing | 500° C. | 700° C. | 800° C. |
| C | 96.97 | 94.79 | 93.91 | 89.44 |
| N | — | 2.35 | 3.6 | 3.95 |
| Ti | — | — | — | 1.78 |
| O | 3.03 | 2.86 | 2.48 | 4.83 |

The rights of this invention is not limited to the example mentioned above but is justified as written on the claim scope, and that the person having the equal knowledge is able to make various changes and adaptions is evident.

What is claimed:

1. A manufacturing method for electrode wherein a substrate for electrode made from Ti, Nb, W, or stainless steel is prepared;
a surface of the substrate is roughened to give surface roughness;
an sublayer (substrate: nitrified layer/substrate:C:N combined layer) formed including nitrified layer and C and N on the above nitrified layer by coating a combined layer including C and N;
and the DLC (Diamond Like Carbon) layer is coated on the sublayer to form a multi-coating layer, substrate: nitrified layer/substrate:C:N combined layer/DLC on the substrate;
the electrode with the multi-coating layer is manufactured;
the electrode is annealed to get electrochemical activation and for N component in the sublayer to diffuse into the DLC (Diamond Like Carbon) by solid diffusion.

2. In claim 1, the manufacturing method for electrode wherein the temperature of annealing the electrode containing the DLC is in 300 to 900° C.

3. In claim 2, the manufacturing method for electrode wherein the time for annealing the electrode containing DLC is shortened as the temperature is increased.

4. In claim 1, the manufacturing method for electrode wherein etching or blasting is performed on the substrate to give roughness.

5. In claim 1, the manufacturing method for electrode wherein the method further includes a process of cleansing the substrate after giving surface roughness to the substrate before forming nitrified layer, and the process includes inserting inert gases into the chamber and discharging plasma for plasma cleaning.

6. In claim 1, the manufacturing method for electrode wherein in order to form the nitrified layer on the substrate, inert gas and nitrogen is inserted and a nitrified layer is deposited, and in order to form the combined coating layer containing C and N, inert gas, nitrogen and hydrocarbon are inserted and the combined layer is deposited, and in order to form the DLC coating layer, inert gases and hydrocarbon is inserted and DLC coating layer is deposited.

7. A water-treatment electrode manufactured from method of anyone of claim 1 to claim 6.

8. A water-treatment electrode, comprising:
an electrode substrate made from Ti, Nb, W or stainless steel;
a sublayer Including a combined layer including nitrified layer and C and N;
the DLC layer on the sublayer, and the above DLC layer having sp² and sp³ mixed structures, and including the N diffused from the sublayer.

9. In claim 8, the water-treatment electrode wherein the substrate has minute surface roughness.

10. In claim 8, the water-treatment electrode wherein the thickness of the DLC layer is in 500 nm to 10 μm.
